(19) United States
(12) Patent Application Publication
(10) Pub. No.: US 2021/0197485 A1
(43) Pub. Date: Jul. 1, 2021

(54) 3D OBJECT PART SECTION FORMATION

(71) Applicant: HEWLETT-PACKARD DEVELOPMENT COMPANY, L.P., Spring, TX (US)

(72) Inventors: David C. WOODLOCK, Vancouver, WA (US); Lee DOCKSTADER, Charlotte, NC (US)

(73) Assignee: HEWLETT-PACKARD DEVELOPMENT COMPANY, L.P., Spring, TX (US)

(21) Appl. No.: 16/075,676

(22) PCT Filed: Mar. 30, 2017
(86) PCT No.: PCT/US2017/025074

§ 371 Date: Aug. 6, 2018

(51) Int. Cl. B29C 64/393; B29C 64/165; B33Y 10/00; B33Y 30/00; B33Y 50/02

(52) U.S. Cl. CPC B29C 64/393; B29C 64/165; B33Y 50/02; B33Y 30/00; B33Y 10/00

(57) ABSTRACT

According to examples, an apparatus may include forming components and a controller to control the forming components to fuse build material particles located in a selected area of a layer of build material particles forming a part section of a 3D object, in which the selected area is within and borders a selected boundary. The controller may also wait for a period of time to allow the part section to shrink to form a shrunken part section and, following the period of time, fuse build material particles located in a certain area around the shrunken part section, in which the certain area occupies a preset distance originating around the selected boundary of the layer of build material particles and extending toward an interior of the part section, and the preset distance corresponds to an amount of shrinkage predicted to occur in the part section during the period of time.

### BACKGROUND

3D manufacturing apparatuses that employ additive manufacturing techniques to build or print parts are gaining in popularity and use. Some additive manufacturing techniques employ a layering process in which particles of build material are spread into a layer and selectively fused together. Following that process, additional particles are spread into another layer and selectively fused together. This process may be repeated for a number of times to build up a 3D part having a desired configuration.

### BRIEF DESCRIPTION OF THE DRAWINGS

Features of the present disclosure are illustrated by way of example and not limited in the following figure(s), in which like numerals indicate like elements, in which:

FIG. 1A shows a diagram of an example apparatus that may be implemented to fabricate 3D objects;

FIG. 1B shows multiple stages of the formation of a part section shown in FIG. 1A;

FIG. 2 shows an isometric view of another example apparatus that may be implemented to fabricate 3D objects;

FIG. 3 shows a block diagram of another example apparatus; and

FIG. 4 shows a flow diagram of an example method for forming a part section of a 3D object.

### DETAILED DESCRIPTION

Disclosed herein are apparatuses and methods for forming part sections of a 3D object through use of multiple fusing operations. The apparatuses disclosed herein may include forming components and a controller to control the forming components. Particularly, the controller may control the forming components to fuse build material particles located in a selected area of a layer of build material particles, in which build material particles in the selected area form a part section of a 3D object. The controller may wait for a period of time to allow the part section to shrink in size. During the period of time, the density of the part section may increase and thus, the volume of the part section may decrease, as the part section hardens from a melted state during a fusing operation. The amount of shrinkage may not be consistent around the sides of the part section and may also vary for different layers. As such, forming the part section to initially have a relatively larger size such that the part section has a desired size when cooled may not result in an accurate part section formation. Inaccurate part sections may also result in a 3D object having inaccurate dimensions.

According to examples, following the period of time, the controller may control the forming components to fuse build material particles located in a certain area around the shrunken part section. The certain area may occupy a preset distance originating at or around the selected boundary of the layer of build material particles and extending toward an interior of the part section. The preset distance may correspond to an amount of shrinkage predicted to occur in the part section during the period of time. The certain area may also overlap with a portion, e.g., the edges, of the shrunken part section such that build material particles in the certain area may be fused with the shrunken part section. Fused build material particles in the certain area may also shrink, but may shrink a relatively smaller amount than the shrunken part section due to the relatively smaller area that the certain area encompasses. Additional fusing operations may be performed around the edges of the part section to build up and/or improve the accuracy of the part section.

Through implementation of the methods and apparatuses disclosed herein, part sections may be formed to have surfaces that closely match surfaces of an intended 3D object. As such, the methods and apparatuses disclosed herein may form 3D objects that have surfaces that accurately match an intended design for the 3D objects. According to examples, the additional areas at which build material particles are fused together around a shrunken part section may depend upon a selected print quality for the 3D object. That is, for instance, an additional area around the shrunken part section may not be fused with the shrunken part section in instances in which the desired print quality is low and/or the 3D object is to be printed in a relatively fast manner. Likewise, an additional area or multiple additional areas may be fused with the shrunken part section in instances in which the desired print quality is high, e.g., a 3D object having more accurate surfaces is desired.

Before continuing, it is noted that as used herein, the terms “includes” and “including” mean, but are not limited to, “includes” or “including” and “includes at least” or “including at least.” The term “based on” means, but is not limited to, “based on” and “based at least in part on.”

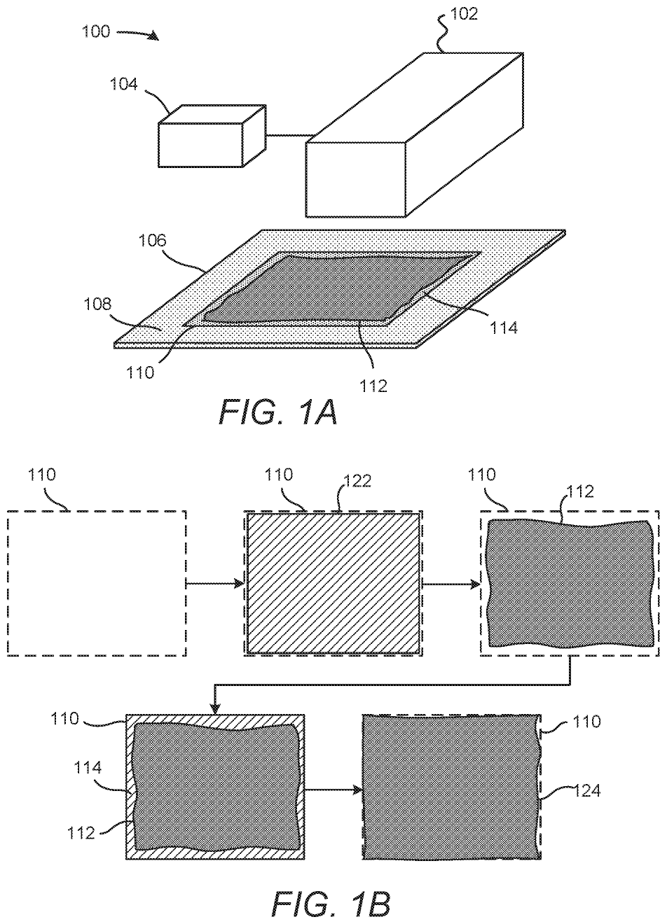

With reference first to FIG. 1A, there is shown a diagram of an example apparatus 100 that may be implemented to fabricate 3D objects. It should be understood that the apparatus 100 depicted in FIG. 1A may include additional components and that some of the components described herein may be removed and/or modified without departing from a scope of the apparatus 100 disclosed herein.

The apparatus 100 may be a three-dimensional (3D) fabrication device and may include forming components 102. The forming components 102 may include various components for additively printing/fabricating 3D objects from a powder material. According to examples, the apparatus 100 is to print 3D objects from layers of build material particles upon which fusing agent is selectively deposited and fused. In these examples, the forming components 102 may include a recoater, a fusing device, a fusing agent delivery device, etc. In other examples, the apparatus 100 may fabricate 3D objects from layers of build material particles through selective application of a laser beam to selectively fuse the build material particles into a desired part on each of the layers. In these examples, the forming components 102 may include a recoater, a laser beam source, etc.

The apparatus 100 may also include a controller 104 to control the forming components 102 to print/fabricate portions of 3D objects in multiple layers 106 of build material particles 108. The controller 104 may be a computing device, a semiconductor-based microprocessor, a central processing unit (CPU), an application specific integrated circuit (ASIC), a field-programmable gate array (FPGA), and/or other type of hardware device.

The controller 104 may control the forming components 102 to fuse build material particles 108 located in a selected area of a layer 106 of build material particles 108 to form a part section, in which the selected area is within and borders a selected boundary 110 on the layer 106. With reference also to FIG. 1B, which shows multiple stages of the formation of the part section, the build material particles 108 inside the selected boundary 110, which may also be considered as a desired boundary or geometry of the part section, may be fused together as indicated as reference numeral 122. During fusing, the forming components 102 may apply fusing radiation onto the build material particles 108 to melt build material particles 108 in the selected area, which is inside of and borders the selected boundary 110. Reference numeral 122 may represent the melted build material particles 108 within the selected boundary 110. Once application of the fusing radiation is stopped, the melted build material particles 108 may begin to cool, fuse together, and harden.

During the hardening process, the part section formed of the melted build material particles 108 inside the selected boundary 110 may shrink in size as denoted by the shrunken part section boundary 112. Additionally, the part section may shrink in size as the part section solidifies from the melted state because, for instance, the part section in solid or partially solid form has a greater density than when the part section was in melted or partially melted form. In other words, the volume of the part section may decrease as the part section solidifies. The part section may shrink by some percentage as measured around the boundary 110 of the part section, in which the amount of shrinkage may depend upon the type of the build material particles 108, the amount of radiation applied, ambient conditions, etc. The shrinkage may be a relatively small percentage, e.g., around 1 percent in some examples, of the initial size, but may not be uniform around the boundary 110 of the part section as shown in FIGS. 1A and 1B.

In addition, during shrinkage of the part section, build material particles 108 adjacent to the part section may be drawn toward the directions in which the part section is shrinking. In other words, gaps that may be forming between the part section and surrounding build material particles 108 may at be least partially filled by the surrounding build material particles 108 that are drawn toward the interior of the part section 110. Surrounding build material particles 108 may be drawn toward the interior of the part section 110 through adhesive forces existing between the surrounding build material particles 108 and build material particles 108 in the part section 110.

Following a period of time after the fusing radiation has been applied or after cessation of the fusing radiation application on the part section, the controller 104 may control the forming components 102 to fuse build material particles 108 located in a certain area 114 around the shrunken part section boundary 112 as shown in FIGS. 1A and 1B. The build material particles 108 in the certain area 114 may include build material particles 108 that have been drawn into that area from outside of the part section 110 boundary as the part section 110 shrank. The period of time may be equivalent to an amount of time that it may take the fusing components 102 to return to a position to fuse build material particles 108 in the certain area 114. In addition or in other examples, the period of time may be equivalent to an amount of time that it may take for volumetric shrinkage of the part section in the selected boundary 110 to occur. In other examples, the period of time may be a relatively short period of time, e.g., immediately following cessation of the fusing radiation application.

The certain area 114 may be defined as an area that is to encompass the area between the selected boundary 110, e.g., the original boundary at which the part section was formed, and the shrunken part section boundary 112. Particularly, the certain area 114 may occupy a predetermined distance from the selected boundary 110 toward the interior of the shrunken part section boundary 112 along one or multiple sides of the shrunken part section boundary 112. The area that the certain area 114 covers may be based upon, for instance, an amount of shrinkage that is predicted to occur in the part section. The certain area 114 may thus differ for different types of build material particles 108, different types of fusing radiation devices, different energy levels at which the fusing radiation is applied, ambient conditions, etc.

According to examples, the controller 104 may define the certain area 114 as incorporating a preset distance from the selected boundary 110 toward the shrunken part section boundary 112. The preset distance may be a distance that is likely to overlap with a small portion of the shrunken part section such that the build material particles 108 in the certain area 114 may be fused with build material particles 108 along the shrunken part section boundary 112. By way of particular example, the preset distance may be selected to cause between about 10 and about 100 microns of overlap between the build material particles 108 in the certain area 114 and the build material particles 108 at the edges of the shrunken part section boundary 112. In any regard, the preset distance may be determined through testing of previously fabricated part sections and determinations of the amount of shrinkage that occurs during the fabrication of the part sections. For instance, the preset distance may be determined to be a distance that corresponds to an average amount of shrinkage that occurred over multiple tests, a maximum amount of shrinkage that occurred over multiple tests, etc. Additionally, respective preset distances may be determined through testing of different part section sizes and shapes. Moreover, respective preset distances may be determined for different types of build material particles 108, different types of fusing radiation devices, different energy levels at which the fusing radiation is applied, ambient conditions, etc., through testing of shrinkage that may occur under these different scenarios.

According to examples, the controller 104 may set the preset distance for the certain area 114 to be the same around the periphery of the selected boundary 110. In other examples, the controller 104 may set different preset distances for the certain area 114 for different sections around the periphery of the selected boundary 110. In addition, the controller 104 may set the same or different preset distances for the certain area 114 for different layers 106 of build material particles 108.

In any regard, during fusing, build material particles 108 in the certain area 114 along with some of the build material particles 108 around the edges of the shrunken part section 112 may melt. In addition, once application of the fusing radiation is stopped, the melted build material particles 108 in the certain area 114 and along the edges of the shrunken part section 112 may begin to cool, fuse together, and harden. That is, the melted build material particles 108 in the certain area 114 and along the edges of the shrunken part section 112 may fuse together and form the part section 124 as shown in FIG. 1B. Although the fused build material particles 108 in the certain area 114 are also subject to shrinkage, as that area is likely much smaller than the area encompassed within the selected boundary 110, the amount of shrinkage may be relatively smaller as also shown in FIG. 1B. As a result, part sections of a 3D object may be formed in respective layers 106 of build material particles 108 to have more accurate surfaces, e.g., surfaces that closely match the original designs of the part sections. The part sections may thus form a 3D object that also closely matches the original design for the 3D object.

According to examples, the quality of the 3D object may be user-defined and the fusing of build material particles 108 in the certain area 114 may depend upon the selected quality of the 3D object. By way of particular example, build material particles 108 in the certain area 114 may be fused in a fusing operation subsequent to the fusing operation performed to form the shrunken part section 112 in instances in which a higher quality level is selected, e.g., when the print quality setting exceeds a predetermined level, and not fused in instance in which a lower quality level is selected. Moreover, an additional fusing operation or additional fusing operations may be performed as further operations to increase the size and/or quality of the part section 124.

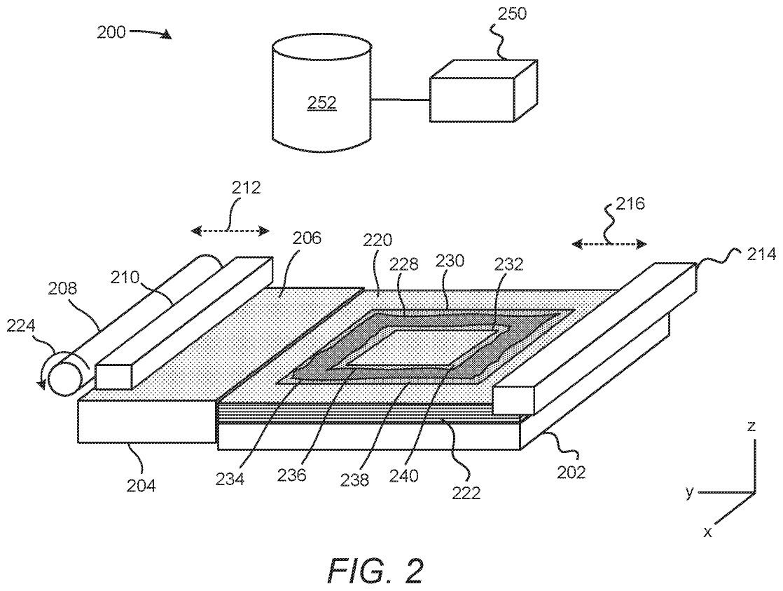

With reference now to FIG. 2, there is shown an isometric view of another example apparatus 200, e.g., a 3D printer, for generating, building, or printing 3D objects, that may be implemented to fabricate 3D objects having accurate surfaces as disclosed herein. It should be understood that the apparatus 200 depicted in FIG. 2 may include additional components and that some of the components described herein may be removed and/or modified without departing from a scope of the apparatus 200 disclosed herein.

The apparatus 200 may include a build area platform 202, a build material supply 204 containing build material particles 206, and a recoater 208. The build material supply 204 may be a container or surface that is used to position build material particles 206 between the recoater 208 and the build area platform 202. The build material supply 204 may be a hopper or a surface upon which the build material particles 206 may be supplied, for instance, from a build material source (not shown) located above or adjacent to the build material supply 204. Additionally, or alternatively, the build material supply 204 may include a mechanism to provide, e.g., move, the build material particles 206 from a storage location to a position to be spread onto the build area platform 202 or a previously formed layer of build material particles 206. For instance, the build material supply 204 may include a hopper, an auger conveyer, a plowing mechanism, or the like. Generally speaking, 3D objects or parts may be generated from the build material particles 206.

The build material particles 206 may be particles, e.g., in the form of a powder, fibers, or the like, and may be formed of materials such as polymers, plastics, metals, ceramics, or combinations thereof. The build material particles 206 may be formed to have widths that are formed according to a specified average dimension. By way of particular example, the build material particles 206 may be formed to have dimensions, e.g., widths, heights, diameters, and/or lengths, that are on average, around 50 microns. In other examples, the build material particles 206 may be formed to have other average dimensions, such as around 40 microns, 60 microns, or the like.

The recoater 208 may be moved in the directions denoted by the arrow 212 to spread the build material particles 206 as a layer 220 having a substantially uniform thickness over previously formed layers 222. According to examples, in addition to moving in the directions 212 during build material particle 206 spreading operations, the recoater 208 may rotate as indicated by the arrow 224. Rotation of the recoater 208 in the direction indicated by the arrow 224, e.g., counterclockwise when the build material particles 206 are spread in a left-to-right direction, may result in a relatively more even spreading of the build material particles 206. In other examples, the recoater 208 may not rotate and/or may have a different configuration than as depicted in FIG. 2. For instance, the recoater 208 may be a blade, a doctor blade, a rake, or the like.

The recoater 208 may be movable in a direction away from the applied layer 220 of build material particles 206, e.g., in a vertical direction. The recoater 208 may be moved away, e.g., raised, from the applied layer 220 of build material particles 206 prior to a return movement of the recoater 208. In some examples, the recoater 208 may be placed into contact with the layer 220 and may be rotated in a direction counter to the direction 224 during the return movement.

The apparatus 200 may further include an agent delivery device 214 that may move in directions denoted by the arrow 216, e.g., along the y-axis. In any regard, the agent delivery device 214 may include a plurality of orifices through which a fusing agent may selectively be expelled for delivery onto a topmost layer 220 of build material particles 206. The fusing agent may be a liquid that is to absorb fusing radiation (e.g., in the form of light and/or heat) to cause the build material particles 206 upon which the fusing agent has been deposited to fuse together when fusing radiation, e.g., electromagnetic radiation within a certain range, is applied onto the fusing agent.

In addition or in other examples, the agent delivery device 214 may selectively deliver a detailing agent onto the layer 220 of build material particles 206. The detailing agent may be a liquid that may absorb significantly less of the fusing radiation as compared with the fusing agent. In one example, the detailing agent may prevent or significantly reduce the fusing together of the build material particles 206 upon which the detailing agent has been deposited. In other examples, the detailing agent may be implemented to provide coloring to exterior portions of the build material particles 206 that have been fused together. Various additives and/or catalysts that either enhance or reduce radiation absorption may be included in the agent or agents delivered onto the layer 220 of build material particles 206. For instance, the agent or agents may include a radiation absorbing agent, i.e., an active material, metal nanoparticles, or the like. The agent or agents may additionally or alternatively include any of a co-solvent, a surfactant, a biocide, an anti-kogation agent, a dispersant, and/or combinations thereof.

FIG. 2 depicts a plurality of layers 222 of build material particles 206 that have previously been formed on the build area platform 202. The layers 222 may each be formed to a substantially uniform thickness across the build area platform 202. In an example, the thicknesses of the layers 222 may range from about 90 μm to about 110 μm, although thinner or thicker layers may also be used. For example, the thicknesses of the layers 222 may range from about 20 μm to about 200 μm, or from about 50 μm to about 200 μm.

The agent delivery device 214 may be controlled to selectively deliver droplets of a fusing agent onto the build material particles 206 in a topmost layer 220. That is, the agent delivery device 214 may be controlled to selectively deliver droplets of the fusing agent onto areas of the layer 220 containing build material particles 206 that are to be fused together to form a part section of a 3D object. The apparatus 200 may also include an additional agent delivery device (not shown) that may be controlled to selectively deliver droplets of the fusing agent or another type of agent. In any regard, the agent delivery device(s) 214 may be a thermal inkjet printhead, a piezoelectric printhead, or the like, and may extend a width of the build area platform 202.

In other examples in which the agent delivery device 214 does not extend the width of the build area platform 202, the agent delivery device 214 may be scanned along the x-axis to thus enable the agent delivery device 214 to be positioned over a majority of the area above the build area platform 202. The agent delivery device 214 may thus be attached to a moving XY stage or a translational carriage (neither of which is shown) that is to move the agent delivery device 214 adjacent to the build area platform 202 in order to deposit the agent in certain areas of the layer 220.

According to examples, during a printing pass, the agent delivery device 214 may deliver fusing agent onto a selected area that is within and borders a selected outer boundary 230 and a selected inner boundary 232. Following delivery of the fusing agent, the energy source 210 may be implemented to apply fusing radiation onto the build material particles 206 in the layer 220. Particularly, the energy source 210 may be activated and moved across the layer 220, for instance, along the direction indicated by the arrow 212 to apply fusing radiation in the form of light and/or heat onto the build material particles 206. Examples of the energy source 210 may include UV, IR or near-IR curing lamps, IR or near-IR light emitting diodes (LED), halogen lamps emitting in the visible and near-IR range, lasers with desirable electromagnetic wavelengths, or the like. The type of energy source 210 may depend, at least in part, on the type of active material used in the agent(s).

Application of the fusing radiation onto the build material particles 206 may cause the build material particles 206 upon which the fusing agent has been applied, e.g., the build material particles 206 in the area between the boundaries 230 and 232, to melt and subsequently fuse together following removal of the application of fusing radiation, i.e., during cooling. Additionally, as discussed above, during the fusing process, the part section 228 formed with the fused build material particles 206, e.g., the part section 228 formed in the area between the boundaries 230 and 232, may shrink in size as denoted by the outer and inner shrunken part section boundaries 234 and 236. The part section 228 may shrink by some amount, in which the amount of shrinkage may depend upon the type of the build material particles 206, the amount of radiation applied, ambient conditions, etc. The shrinkage may be a relatively small percentage, e.g., around 1 percent, of the initial size, but may not be uniform around the outer and inner boundaries 230, 232 of the part section as shown in FIG. 2.

In addition, during shrinkage of the part section 228, the build material particles 206 adjacent to the outer and inner boundaries 234, 236 may be drawn toward the directions in which the part section 228 is shrinking. In other words, gaps that may be forming between the part section 228 and surrounding build material particles 206 may be at least partially filled by the surrounding build material particles 206 that are drawn toward the part section 228. The surrounding build material particles 206 may be drawn toward the part section 228 through adhesive forces existing between the surrounding build material particles 206 and the build material particles 206 forming the part section 228.

Following a period of time after the fusing radiation has been applied or after cessation of the fusing radiation application on the part section 228, the agent delivery device 214 may be scanned across the layer 220 any may apply fusing agent onto build material particles 206 located in certain areas 238, 240 around the shrunken part section 228. The build material particles 108 in the certain areas 238, 240 may include build material particles 108 that have been drawn into those areas from outside of the part section 228 boundary as the part section 228 shrank. The period of time may be equivalent to an amount of time that it may take for the energy source 210 to return to a first position. In addition or in other examples, the period of time may be equivalent to an amount of time that it may take for volumetric shrinkage of the part section 228 to occur. In other examples, the period of time may be a relatively short period of time, e.g., immediately following cessation of the fusing radiation application.

The certain areas 238, 240 may be defined as areas that encompass the areas between the selected boundaries 230, 232, e.g., the original boundary at which the part section 228 was formed, and the shrunken part section boundaries 234, 236. Particularly, the certain area 238 may occupy predetermined distances from the outer boundary 230 toward the interior of the shrunken part section 228 along one or multiple sides of the shrunken part section 228. Likewise, the certain area 240 may occupy predetermined distances from the inner boundary 232 toward the interior of the shrunken part section 228 along one or multiple sides of the shrunken part section 228. The areas that the certain areas 238, 240 cover may be based upon, for instance, an amount of shrinkage that is predicted to occur in the part section 228. The certain areas 238, 240 may thus differ for different types of build material particles 206, different types of energy sources 210, different energy levels at which the fusing radiation is applied, ambient conditions, etc.

According to examples, the certain areas 238, 240 may be defined as incorporating preset distances from the selected boundaries 230, 232 toward the shrunken part section 228 boundaries 234, 236. The preset distances may be distances that are likely to overlap with a small portion of the shrunken part section 228 such that the build material particles 206 in the certain areas 238, 240 may fuse with build material particles 206 along the shrunken part section boundaries 234, 236. By way of particular example, the preset distances may be selected to cause between about 10 and about 100 microns of overlap between the build material particles 206 in the certain areas 238, 240 and the build material particles 206 at the edges of the shrunken part section boundaries 234, 236. In any regard, the preset distances may be determined through testing of previously fabricated part sections and determinations of the amount of shrinkage that occurs during the fabrication of the part sections as discussed above.

According to examples, the preset distances for the certain areas 238, 240 may be determined to be the same around the periphery of the selected boundaries 234, 236. In other examples, the preset distances for the certain areas 238, 240 may be different for different sections around the periphery of the selected boundaries 234, 236. In addition, the same or different preset distances for the certain areas 238, 240 may be set for different layers 222 of the build material particles 206.

As further shown in FIG. 2, the apparatus 200 may include a controller 250 that may control operations of the build area platform 202, the build material particle bin 204, the recoater 208, the energy source 210, and the agent delivery device 214. Particularly, for instance, the controller 250 may control actuators (not shown) to control various operations of the apparatus 200 components. The controller 230 may be similar to the controller 104 depicted in FIG. 1A and may be connected to the apparatus 200 components via communication lines (not shown). In some examples, the energy source 210 may be provided on a common carriage (not shown) with the agent delivery device 214 and thus, the energy source 210 may move concurrently with the agent delivery device 214. In other examples, the energy source 210 may move separately from the agent delivery device 214, e.g., the energy source 210 may move concurrently with the recoater 208. In addition or in other examples, the agent delivery device 214 may move in different directions than as shown in FIG. 2. For instance, the agent delivery device 214 may move in a direction that is perpendicular to the arrow 216, e.g., along the x-axis.

The controller 250 may also be in communication with a data store 252. The data store 252 may be volatile and/or non-volatile memory, such as DRAM, EEPROM, MRAM, phase change RAM (PCRAM), memristor, flash memory, and the like. The data store 252 may include data pertaining to a 3D object to be printed by the apparatus 200. For instance, the data may include the locations in each build material layer 222 that the agent delivery device 214 is to deposit the fusing agent during multiple scans to form the part sections 228 of the 3D object in the layers 222. The controller 250 may use the data to control the locations on each of the layers 222 that the agent delivery device 214 deposits droplets of the fusing agent.

According to other examples, instead of or in addition to the agent delivery device 214, the apparatus 200 may include a melting device, such as a laser beam source, a laser sintering machine, etc. In these examples, the melting device may direct a laser beam to the build material particles 206 located within the boundaries 230, 232 to melt those build material particles 206 such that those build material particles 206 fuse together when cooled. The controller 250 may control the melting device in these examples.

Although not shown, the apparatus 200 may also include warming devices arranged in an array above the build area platform 202. Each of the warming devices may be a lamp or other heat source that is used to apply heat onto spread layers of the build material particles 206, for instance, to maintain the build material particles 206 at or above a predetermined threshold temperature. According to an example, the warming devices may maintain the temperatures of the build material particles 206 at a relatively high temperature that facilitates the selective fusing of the build material particles 206. In addition, or in other examples, the print bed 202 may include heating devices, e.g., resistors.

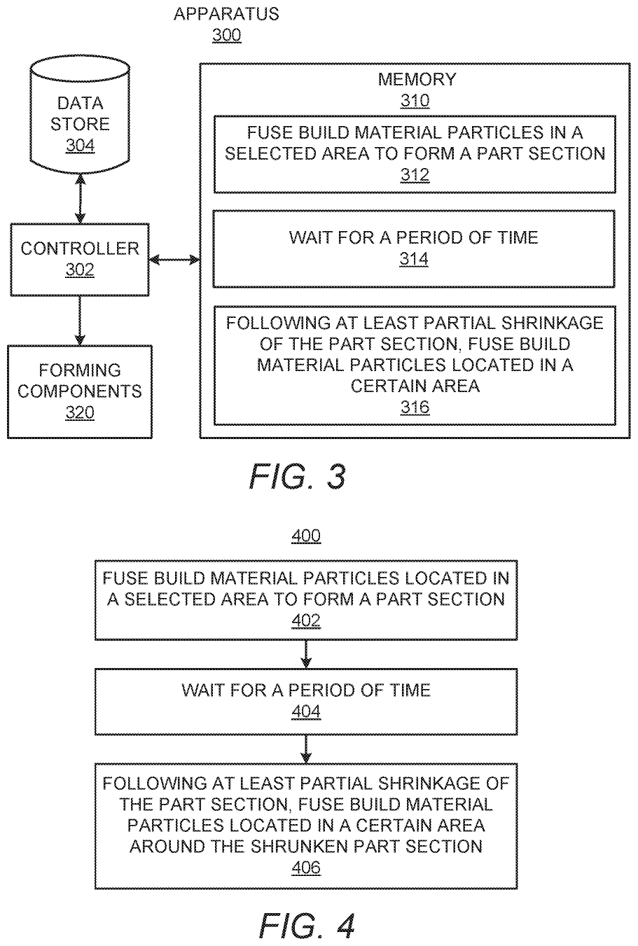

With reference now to FIG. 3, there is shown a simplified block diagram of another example apparatus 100. The apparatus 300 may include a controller 302 that may control operations of the apparatus 300 and may be a semiconductor-based microprocessor, a central processing unit (CPU), an application specific integrated circuit (ASIC), field-programmable gate array (FPGA), and/or other hardware device. The apparatus 300 may also include a memory 310 that may have stored thereon machine readable instructions 312-316 (which may also be termed computer readable instructions) that the controller 302 may execute. The memory 310 may be an electronic, magnetic, optical, or other physical storage device that contains or stores executable instructions. The memory 310 may be, for example, Random Access Memory (RAM), an Electrically Erasable Programmable Read-Only Memory (EEPROM), a storage device, an optical disc, and the like. The memory 310, which may also be referred to as a computer readable storage medium, may be a non-transitory machine-readable storage medium, where the term “non-transitory” does not encompass transitory propagating signals.

The apparatus 300 may be a computing device such as a personal computer, a laptop computer, a smartphone, a server computer, a tablet computer, or the like. In other examples, the apparatus 300 may be or form part of a 3D fabricating device. The controller 302 may communicate instructions to a 3D fabricating device or to forming components 330 over a network, through a wired connection, a bus, or the like.

With reference to FIGS. 2 and 3, the controller 302 may fetch, decode, and execute the instructions 312 to fuse build material particles 206 located within a selected boundary 230 of a layer 220 of build material particles 206. In some examples, the build material particles 206 that are fused together may also be located within an interior selected boundary 232 as shown in FIG. 2. As discussed herein, the build material particles 206 may be fused together in any of various manners to form a part section 228.

The controller 302 may also fetch, decode, and execute the instructions 314 to wait for a period of time. During the period of time, the part section 228 may harden, which may cause the part section 228 to shrink as discussed herein. The period of time may be a predefined period of time as also discussed herein.

The controller 302 may further fetch, decode, and execute the instructions 316 to, following the period of time, fuse build material particles 206 located in a certain area or multiple certain areas 238, 240 around the shrunken part section 228. The certain area(s) 238, 240 may occupy a preset distance originating at the selected boundary or boundaries 230, 232 toward an interior of the shrunken part section 228. Additionally, the preset distance may correspond to an amount of shrinkage predicted or expected to occur in the part section 228 during the period of time. Moreover, the preset distance may extend from the selected boundary or boundaries 230, 232 and may overlap with portions of the shrunken part section 228. According to examples, the controller 302 may fuse build material particles 206 in multiple certain areas, e.g., having different present distances, around the part section 228. In these examples, build material particles 206 may be fused in the multiple certain areas in instances in which different portions of the part section 228 are predicted or expected to undergo different amounts of shrinkage with respect to each other.

Various manners in which the apparatus 300 may be implemented are discussed in greater detail with respect to the method 400 depicted in FIG. 4. Particularly, FIG. 4 depicts a flow diagram of an example method 400 for forming a part section 228 of a 3D object. It should be understood that the method 400 depicted in FIG. 4 may include additional operations and that some of the operations described therein may be removed and/or modified without departing from the scope of the method 400. The description of the method 400 is made with reference to the features depicted in FIGS. 2 and 3 for purposes of illustration.

Generally speaking, the controller 302 of the apparatus 300 may implement or execute some or all of the instructions 312-316 stored on the memory 310 to perform the method 400. Prior to or as part of the execution of the method 400, the controller 302 may execute instructions (not shown) to identify a 3D object to be fabricated. For instance, the controller 302 may access information, such as computer aided design information of the 3D object, which may be stored in the data store 304. The computer aided design information may identify the physical characteristics of the 3D object, for instance, the shapes and dimensions of the 3D object. The 3D object may be broken down into a plurality of part sections to be formed on multiple layers 222 of build material particles 206 such that the controller 302 may control forming components to form the part sections in the multiple layers 222.

At block 402, the controller 302 may execute the instructions 312 to fuse build material particles 206 located within a selected boundary 230 of a layer 220 of build material particles 206, in which build material particles 206 in the selected area form a part section 228. In some examples, the build material particles 206 that are fused together may also be located within an interior selected boundary 232 as shown in FIG. 2. As discussed herein, the build material particles 206 may be fused together in any of various manners to form a part section 228.

In some examples, the controller 302 may control an agent delivery device 214 to deliver fusing agent onto the build material particles 206 located within the selected boundary 230 or boundaries 232 and may control an energy source 210 to apply fusing energy onto a layer 220 on which the build material particles 206 are located. Application of the fusing energy may cause build material particles 206 upon which the fusing agent has been delivered to melt. That is, application of the fusing energy onto the build material particles 206 upon which the fusing agent has not been delivered may not cause those build material particles 206 to melt. In addition, the fusing agent may sufficiently increase the absorption of the fusing energy by the build material particles 206 upon which the fusing agent has been delivered to melt while the fusing energy itself is of insufficient strength to alone cause the build material particles 206 to melt. In other examples, the controller 302 may control an energy source 210, such as a laser beam source, to direct focused fusing energy onto the build material particles 206 within the selected boundary 230 or boundaries 232. The build material particles 206 upon which the focused fusing energy is applied may melt while the build material particles 206 upon which the fusing energy is not applied may not melt.

In any of the examples above, as the melted build material particles 206 cool, the melted build material particles 206 may begin to fuse together into a part section 228. Additionally, the part section 228 may shrink in size as the part section 228 solidifies from the melted state because, for instance, the part section 228 in solid or partially solid form has a greater density than when the part section 228 was in melted or partially melted form. In other words, the volume of the part section 228 may decrease as the part section 228 solidifies. As the part section 228 decreases in volume, the unfused build material particles 206 adjacent to the selected boundary or boundaries 230, 232 may be drawn toward the edges of the part section 228 through gravity and/or adhesive forces between the build material particles 206. As such, the space(s) between the selected boundary or boundaries 230, 232 and the part section 228 may at least be partially filled by additional build material particles 206.

At block 404, the controller 302 may execute the instructions 314 to wait for a period of time. During the period of time, the part section 228 may harden and shrink. The period of time may be a predefined period of time as discussed herein.

At block 406, the controller 302 may execute the instructions 316 to, following the period of time, fuse build material particles 206 located in a certain area or in multiple certain areas 238, 240 around the shrunken part section 228. The certain area(s) 238, 240 may occupy a preset distance originating at the selected boundary or boundaries 230, 232 toward an interior of the shrunken part section 228. As discussed above, the preset distance may be determined through testing and may vary depending upon any of the type fusing radiation device that is employed, the energy level at which the fusing radiation is applied, current ambient conditions, etc., the shape and size of the boundaries 230, 232, etc. For instance, the preset distance may be a distance that is predicted or expected to cover a portion of a space between the selected boundary or boundaries 230, 232 and the edges of the shrunken part section 228 as determined from the previous testing. That is, the preset distance may be predicted to extend from the selected boundary or boundaries 230, 232 to the shrunken part section 228 and may overlap a portion of the edge(s) of the shrunken part section 228.

Build material particles 206 located in the certain area may be fused together and with portions of the shrunken part section 228 in manners similar to those discussed above with respect to the fusing of the build material particles 206 located within the selected boundary or selected boundaries 230, 232. As discussed above, the amount of shrinkage in the part section 228 may not be uniform around the perimeter of the part section 228. As such, even when the certain area 238 or certain areas 238, 240 have uniform widths, the amount of overlap between the certain areas 238, 240 and the edges of the shrunken part section 228 may not be uniform.

According to examples, the controller 302 may fuse additional build material particles 206 around the border or borders of the build material particles 206 fused at block 404. By way of example, the build material particles 206 in the certain area or areas 238, 240 may also shrink and the controller 302 may cause additional build material particles 206 that may have filled or at least partially filled the space between the selected boundary or boundaries 230, 232 and the certain area or areas 238, 240 to be fused together to build up the part section 228. The controller 302 may further fuse additional build material particles 206 around the part section 228 to further enlarge the part section 228 during subsequent build material particle 206 fusing operations. According to examples, the additional fusing operations around the borders of the fused build material particles 206 may be performed to increase an accuracy at which a 3D object is fabricated. That is, for 3D objects that are to be fabricated at lower accuracy levels, the additional fusing operations may not be performed. In contrast, a greater number of additional fusing operations may be performed to fabricate higher accuracy 3D objects.

Blocks 402-406 may be repeated on additional layers of build material particles 206 to form additional part sections 228 of the 3D object. In addition, some or all of the operations set forth in the method 400 may be contained as utilities, programs, or subprograms, in any desired computer accessible medium. In addition, the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
forming components; and
a controller to control the forming components to:
fuse build material particles located in a selected area of a layer of build material particles, wherein build material particles in the selected area form a part section of a three-dimensional (3D) object, and wherein the selected area is within and borders a selected boundary on the layer;
wait for a period of time to allow the part section to shrink to form a shrunken part section; and
following the period of time, fuse build material particles located in a certain area around the shrunken part section, wherein the certain area occupies a preset distance originating around the selected boundary of the layer of build material particles and extending toward an interior of the part section, and wherein the preset distance corresponds to an amount of shrinkage predicted to occur in the part section during the period of time.

2. The apparatus according to claim 1, wherein the forming components include an energy source that is movable over the layer of build material particles and wherein the controller is to control the energy source to apply energy onto the layer of build material particles to fuse build material particles located in the selected area during a pass and to control the energy source to apply energy onto the layer of build material particles to fuse build material particles in the certain area around the part section during a subsequent pass.

3. The apparatus according to claim 2, wherein the forming components further include an agent delivery device, wherein the controller is to control the agent delivery device to deliver a fusing agent onto the build material particles in the selected area, and wherein application of energy onto the layer of build material particles is to cause the build material particles upon which the fusing agent has been delivered to fuse and form the part section.

4. The apparatus according to claim 2, wherein the forming components further include an agent delivery device and wherein the controller is to control the agent delivery device to deliver a fusing agent onto the build material particles in the certain area, and wherein application of energy onto the layer of build material particles during the subsequent pass is to cause the build material particles upon which the fusing agent has been delivered to fuse and form a boundary portion of the part section.

5. The apparatus according to claim 1, wherein the controller is further to control the forming components to, following the period of time, fuse build material particles located in another certain area adjacent to the shrunken part section, wherein the another certain area occupies a second present distance originating from the selected boundary and extending toward the interior of the part section, the second preset distance corresponding to a second amount of shrinkage predicted to occur in the part section at the another certain area.

6. The apparatus according to claim 1, wherein the controller is to determine a print quality setting for the 3D object and to fuse build material particles located in the certain area in response to a determination that the print quality setting for the 3D object exceeds a predetermined level.

7. The apparatus according to claim 1, wherein the selected area includes an interior boundary and wherein the controller is to control the forming components to fuse build material particles located in a second certain area following shrinkage of the part section, wherein the second certain area occupies a predefined distance originating near the interior boundary and extending toward the selected boundary.

8. A method comprising:
fusing build material particles located in a selected area of a layer of build material particles, wherein build material particles in the selected area of the layer of build material particles form a part section of a three-dimensional (3D) object, and wherein the selected area is within and borders a selected boundary on the layer;
waiting for a period of time, wherein the part section is to shrink during the period of time to form a shrunken part section; and
following the period of time, fusing build material particles located in a certain area around the shrunken part section, wherein the certain area occupies a preset distance originating at the selected boundary of the layer of build material particles and extending toward an interior of the shrunken part section, and wherein the preset distance corresponds to an amount of shrinkage that is expected to occur by the part section during the period of time.

9. The method according to claim 8, wherein fusing the build material particles located in the selected area of the layer comprises:
delivering a fusing agent onto build material particles in the selected area; and
during a fusing pass of an energy source, applying fusing energy onto the layer of build material particles to cause build material particles upon which the fusing agent has been delivered to melt and subsequently fuse together.

10. The method according to claim 9, wherein fusing the build material particles located in the certain area comprises:
delivering the fusing agent onto build material particles in the certain area; and
during a subsequent fusing pass of the energy source, applying fusing energy onto the layer of build material particles to cause build material particles in the certain area upon which the fusing agent has been delivered to melt and subsequently fuse together.

11. The method according to claim 8, further comprising:
following the period of time, fusing build material particles located in another certain area adjacent to the shrunken part section, wherein the another certain area occupies a second present distance originating from the selected boundary and extending toward the interior of the part section, the second preset distance corresponding to a second amount of shrinkage predicted to occur in the part section at the another certain area.

12. The method according to claim 8, wherein the selected area includes an interior boundary, said method further comprising:
following the period of time, fusing build material particles located in a second certain area, wherein the second certain area occupies a second preset distance originating at the interior boundary and extending toward the selected boundary, and wherein the second preset distance corresponds to an amount of shrinkage that is expected to occur by the part section along the second certain area during the period of time.

13. A three-dimensional (3D) printer comprising:
a recoater to spread build material particles into a layer;
an agent delivery device;
an energy source; and
a controller to:
control the agent delivery device to deliver a fusing agent within a selected boundary on a layer of build material particles, wherein build material particles in the selected area form a part section of a three-dimensional (3D) object;
control the energy source to apply fusing energy onto the layer of build material particles to melt and fuse the build material particles located within the selected boundary;
wait for a period of time, wherein the part section is to shrink during the period of time to form a shrunken part section;
control the agent delivery device to deliver fusing agent onto build material particles located in a certain area around the shrunken part section after the period of time; and
control the energy source to apply fusing energy onto the layer of build material particles to melt build material particles located in the certain area.

14. The 3D printer according to claim 13, wherein the certain area occupies a preset distance originating at the selected boundary of the layer of build material particles toward an interior of the shrunken part section and wherein the preset distance corresponds to an amount of shrinkage that is expected to occur by the part section during the period of time.

15. The 3D printer according to claim 13, wherein the selected area includes an interior boundary and wherein the controller is further to:
control the agent delivery device to deliver fusing agent onto build material particles located in a second certain area around the part section after the period of time, wherein the second certain area occupies a second preset distance originating at the interior boundary and extending toward the selected boundary, and wherein the second preset distance corresponds to an amount of shrinkage that is expected to occur by the part section along the second certain area during the period of time; and
control the energy source to apply fusing energy onto the layer of build material particles.
